(19) United States
(12) Patent Application Publication
(10) Pub. No.: US 2006/0215508 A1
(43) Pub. Date: Sep. 28, 2006

(54) Optical semiconductor device

(75) Inventors: Naoki Nakanishi, Kusatsu-shi (JP); Masayuki Ono, Takatsuki-shi (JP); Masahiko Nishimoto, Settsu-shi (JP); Tatsuya Nakamori, Nagaokakyo-shi (JP)

Correspondence Address: HAMRE, SCHUMANN, MUELLER & LARSON P.C., P.O. BOX 2902-0902, MINNEAPOLIS, MN, 55402, US

(73) Assignee: Matsushita Electric Industrial Co., Ltd., Kadoma-shi (JP)

(21) Appl. No.: 11/352,648

(22) Filed: Feb. 13, 2006

(30) Foreign Application Priority Data
Mar. 24, 2005 (JP) 2005-086507

(51) Int. Cl. G11B 7/00

(52) U.S. Cl. 369/44.37

(57) ABSTRACT

An optical semiconductor device both capable of recording and reproducing information with respect to plural optical disks having different track pitches and capable of shortening an assembly time and achieving a cost reduction without the need to make a highly-precise assembly adjustment is provided. An optical semiconductor device is constituted by a semiconductor laser element, an emitted light beam branching element for branching a light beam emitted from the semiconductor laser element into a main beam and a plurality of sub beams, an objective lens for focusing the main beam and the sub beams onto an optical disk, and a light-receiving element for signal detection for detecting each of the main beam and the sub beams reflected by the optical disk. Further, a light distribution of the sub beams branched by the emitted light beam branching element has a shape equal to or narrower in an optical disk radial direction than a shape obtained by bisecting a light distribution of the main beam when the sub beams enter the objective lens.

### BACKGROUND OF THE INVENTION

1. Field of the Invention

The present invention relates to an optical semiconductor device for recording information on an information recording medium such as an optical disk and reproducing and erasing information recorded on an information recording medium.

2. Description of Related Art

When recording information on an optical disk or reproducing information recorded on an optical disk, it is necessary to perform a tracking operation, which makes a light beam follow a track on the optical disk accurately. In recent years, with the diversification of optical disk specifications, there has been a need to perform a stable tracking operation with respect to a plurality of optical disks having different track pitches. Several methods have been reported and commercialized as a method for detecting a tracking signal, and the most common method is a push-pull method.

The following is a description of the push-pull method, with reference to FIGS. 13 to 16. FIG. 13 shows a schematic configuration of a conventional optical semiconductor device for detecting a tracking signal by the push-pull method. FIG. 14 is a drawing for describing a light beam reflected from an optical disk in the conventional optical semiconductor device. FIG. 15 is a drawing for describing a light beam reflected from the optical disk in the conventional optical semiconductor device when an objective lens is shifted. FIG. 16 is a drawing for describing a light beam reflected from the optical disk in the conventional optical semiconductor device when the optical disk is inclined.

As shown in FIG. 13, a light beam emitted from a semiconductor laser element 101 is turned into parallel light by a collimator lens 102, passes through a beam splitter 105 and then is focused by an objective lens 103 onto an optical disk 104. The light beam focused onto the optical disk 104 is diffracted by a track 108 as shown in FIG. 14, so that interference patterns 112a and 112b appear in the reflected light beam due to an interference between zero-order diffraction light 110 and +first-order diffraction light 111a and that between the zero-order diffraction light 110 and −first-order diffraction light 111b. The reflected light beam 109 having the interference patterns 112a and 112b is reflected by the beam splitter 105, focused by a focusing lens 106 onto a light-receiving element 107 and then detected. The light-receiving element 107 is divided into two regions, namely, light-receiving regions 107a and 107b that are aligned along a radial direction of the optical disk 104 (an optical disk radial direction).

The intensities of the interference patterns 112a and 112b are equal when a beam spot is located at the center of the track 108 in the optical disk 104 as shown in FIG. 14, and they become unequal as the beam spot moves away from the center of the track 108. A differential signal between them is called a push-pull signal and can be detected by obtaining a differential signal between the two-divided light-receiving regions 107a and 107b in the light-receiving element 107.

In the case of detecting the tracking signal by the push-pull method, such a simple optical configuration can be used, but there also are problems as described below. As shown in FIG. 15, when the objective lens 103 is shifted in the optical disk radial direction, a beam spot 113 on the light-receiving element 107 having the two-divided light-receiving regions 107a and 107b also moves, so that an offset occurs in a tracking error signal even if the beam spot is located at the center of the track 108 (see FIG. 14) on the optical disk 104. Also when the optical disk 104 is inclined as shown in FIG. 16, the beam spot 113 on the light-receiving element 107 having the two-divided light-receiving regions 107a and 107b moves similarly, so that an offset occurs in a tracking error signal. Consequently, these offsets generate an off-track at the time of tracking operation, thus causing a deterioration of a reproducing signal.

As a method for canceling these offsets, a differential push-pull method has been known (see JP 2004-5892 A, JP 2001-325738 A, JP 2001-250250 A and JP 9(1997)-81942 A, for example). In the following, the differential push-pull method will be described, with reference to FIGS. 17 to 20. FIG. 17 shows a schematic configuration of another conventional optical semiconductor device for detecting a tracking signal by the differential push-pull method. FIG. 18 shows where beam spots are located on an optical disk in this conventional optical semiconductor device. FIG. 19 is a plan view showing a light-receiving element in this conventional optical semiconductor device. FIG. 20 shows a signal waveform of a tracking error signal in this conventional optical semiconductor device.

As shown in FIG. 17, a light beam emitted from a semiconductor laser element 101 is diffracted in an X direction in the figure by a diffraction grating element 114 for generating three beams and branched into zero-order light serving as a main beam and +first-order lights serving as sub beams. The above-noted three branched light beams are turned into parallel light by a collimator lens 102, pass through a beam splitter 105, are focused by an objective lens 103 onto an optical disk 104 and then reflected. As shown in FIG. 18, on the optical disk 104, two sub beams 116a and 116b are adjusted so as to be located at positions that are shifted from a main beam 115 by ½ of a pitch of the track 108 (a track pitch) along a radial direction of the optical disk 104.

As shown in FIG. 17, the light beams of the main beam and the sub beams reflected from the optical disk 104 are reflected by the beam splitter 105, focused by a focusing lens 106 onto a light-receiving element 119 and detected. As shown in FIG. 19, the light-receiving element 119 includes three light-receiving elements 120, 121 and 122 that are aligned along a track train direction of the optical disk 104, and each of the light-receiving elements has two-divided light-receiving regions that are aligned along the optical disk radial direction. The central light-receiving element 121 having two-divided light-receiving regions 121a and 121b is used for detecting the main beam. When A and B respectively indicate output signals of the light-receiving regions 121a and 121b, a push-pull signal of a main beam 117 (MPP) is calculated by
MPP=(A−B).
Further, the light-receiving element 120 having two-divided light-receiving regions 120a and 120b and the light-receiving element 122 having two-divided light-receiving regions 122a and 122b are used for detecting the sub beams. When C, D, E and F respectively indicate output signals of the light-receiving regions 120a, 120b, 122a and 122b, push-pull signals of sub beams 118a and 118b (SPP) are calculated by
SPP=(C−D)+(E−F).

FIG. 20 shows the signal waveforms of these signals when the objective lens is shifted. Since the main beam and the sub beams are shifted from each other by ½ of the track pitch, the push-pull signal of the main beam (MPP) shown by (a) in FIG. 20 and the push-pull signals of the sub beams (SPP) shown by (b) in FIG. 20 have phases that are shifted by 180°. On the other hand, DC offset signals, which are generated by the shift of the objective lens 103 and the inclination of the optical disk 104, have the same phase.

Thus, by detecting a tracking error signal (TES) using arithmetic expressions below, it is possible to cancel the offset generated by the shift of the objective lens 103 and the inclination of the optical disk 104 (see (c) in FIG. 20).
TES=MPP−k×SPP
k=α/β
α: light intensity of the main beam
β: light intensity of the sub beams

### SUMMARY OF THE INVENTION

However, in the differential push-pull method described above, since the sub beams have to be located so as to be shifted from the main beam exactly by ½ of the track pitch on the optical disk, there has been a problem in recording and reproducing information using a single optical semiconductor device with respect to optical disks of plural specifications having different track pitches. Further, the diffraction grating element for generating three beams needs to be positioned with high precision when assembling the device, causing problems in shortening an assembly time and reducing a cost.

It is an object of the present invention to solve the above-described problems in the conventional technology and to provide an optical semiconductor device both capable of recording and reproducing information with respect to optical disks of plural specifications having different track pitches and capable of shortening an assembly time and achieving a cost reduction without the need to make a highly-precise assembly adjustment.

In order to achieve the above-mentioned object, a configuration of an optical semiconductor device according to the present invention includes a semiconductor laser element, an emitted light beam branching element for branching a light beam emitted from the semiconductor laser element into a main beam and a plurality of sub beams, an objective lens for focusing the main beam and the sub beams branched by the emitted light beam branching element onto an optical disk, and a light-receiving element for signal detection for detecting each of the main beam and the sub beams reflected by the optical disk. A light distribution of the sub beams branched by the emitted light beam branching element has a shape equal to or narrower in an optical disk radial direction than a shape obtained by bisecting a light distribution of the main beam when the sub beams enter the objective lens.

With the above-described configuration of the optical semiconductor device according to the present invention, an interference region between zero-order diffraction light and ±first-order diffraction lights of the sub beams reflected by the optical disk is hardly generated. Accordingly, a sub beam signal to be detected does not contain a push-pull component generated at the time of crossing a track (a modulated component), so that only a DC offset signal caused by the shift of the objective lens and the inclination of the optical disk is detected. A tracking error signal can be detected by subtracting the DC offset signal obtained from the sub beams from the push-pull signal of the main beam. Also, since the sub beams can be located on the optical disk irrespective of the position of the track, it is possible to record and reproduce information with respect to optical disks of plural specifications having different track pitches. Furthermore, because the position of the sub beams does not have to be adjusted when assembling and adjusting the optical semiconductor device, it becomes possible to shorten the assembly time and achieve the cost reduction.

In the above-described configuration of the optical semiconductor device according to the present invention, it is preferable that the emitted light beam branching element includes a first diffraction grating region and a second diffraction grating region that are aligned along the optical disk radial direction, and a grating pitch of the first diffraction grating region is different from that of the second diffraction grating region. In accordance with this preferable example, when the sub beams branched by the emitted light beam branching element enter the objective lens, their light distribution can be made to have a shape equal to or narrower in the optical disk radial direction than a shape obtained by bisecting a light distribution of the main beam. Moreover, in this case, it is preferable that, when the sub beam that is +first-order diffracted by the first diffraction grating region is a first sub beam, the sub beam that is −first-order diffracted by the first diffraction grating region is a second sub beam, the sub beam that is +first-order diffracted by the second diffraction grating region is a third sub beam and the sub beam that is −first-order diffracted by the second diffraction grating region is a fourth sub beam, both of a space between the first sub beam and the third sub beam and a space between the second sub beam and the fourth sub beam are equal to or larger than a spot size of the main beam on the optical disk. In accordance with this preferable example, the sub beams are separated sufficiently from each other in the track train direction, so that the interference region between the zero-order diffraction light and the +first-order diffraction lights of the sub beams reflected by the optical disk hardly is generated.

Also, in the above-described configuration of the optical semiconductor device according to the present invention, it is preferable that the emitted light beam branching element includes a first diffraction grating region and a second diffraction grating region that are aligned along a track train direction and a third diffraction grating region and a fourth diffraction grating region that are aligned with the first diffraction grating region and the second diffraction grating region respectively along the optical disk radial direction, the first and fourth diffraction grating regions have an equal grating pitch, and the second and third diffraction grating regions have an equal grating pitch that is different from the grating pitch of the first and fourth diffraction grating regions. In accordance with this preferable example, the intensity of the sub beams diffracted by the first and second diffraction grating regions and that of the sub beams diffracted by the third and fourth diffraction grating regions are equal, so that it is possible to detect a stable tracking error signal without any offset even in the case where a semiconductor laser element having a steep far field distribution in the track train direction is mounted. Also, in this case, it is preferable that, when the sub beam that is +first-order diffracted by the first diffraction grating region is a first sub beam, the sub beam that is −first-order diffracted by the second diffraction grating region is a second sub beam, the sub beam that is +first-order diffracted by the third diffraction grating region is a third sub beam and the sub beam that is −first-order diffracted by the fourth diffraction grating region is a fourth sub beam, both of a space between the first sub beam and the third sub beam and a space between the second sub beam and the fourth sub beam are equal to or larger than a spot size of the main beam on the optical disk. In accordance with this preferable example, the sub beams are separated sufficiently from each other in the track train direction, so that the interference region between the zero-order diffraction light and the +first-order diffraction lights of the sub beams reflected by the optical disk hardly is generated.

Further, in the above-described configuration of the optical semiconductor device according to the present invention, it is preferable that the emitted light beam branching element is divided into three parts both along the optical disk radial direction and along a track train direction, and four corner areas of the emitted light beam branching element are provided with diffraction gratings for generating the sub beams. In accordance with this preferable example, the light distribution of the sub beams when entering the objective lens has a shape equal to or narrower in the optical disk radial direction than a shape obtained by bisecting the light distribution of the main beam even when the objective lens is shifted. Thus, the interference region between the zero-order diffraction light and the ±first-order diffraction lights of the sub beams reflected by the optical disk is not generated. Also, in this case, it is preferable that the diffraction gratings for generating the sub beams include a first diffraction grating and a second diffraction grating that are aligned along the track train direction and a third diffraction grating and a fourth diffraction grating that are aligned with the first diffraction grating and the second diffraction grating respectively along the optical disk radial direction, the first and fourth diffraction gratings have an equal grating pitch, and the second and third diffraction gratings have an equal grating pitch that is different from the grating pitch of the first and fourth diffraction gratings. Also, in this case, it is preferable that the diffraction gratings for generating the sub beams include a first diffraction grating and a second diffraction grating that are aligned along the track train direction and a third diffraction grating and a fourth diffraction grating that are aligned with the first diffraction grating and the second diffraction grating respectively along the optical disk radial direction, and the first to fourth diffraction gratings are constituted by gratings extending along an oblique direction to the optical disk radial direction that are aligned along a direction orthogonal to the oblique direction. In accordance with these preferable examples, when the sub beams branched by the emitted light beam branching element enter the objective lens, their light distribution can be made to have a shape equal to or narrower in the optical disk radial direction than a shape obtained by bisecting a light distribution of the main beam even in the case where the objective lens is shifted.

According to the present invention, it is possible to provide an optical semiconductor device both capable of recording and reproducing information with respect to optical disks of plural specifications having different track pitches and capable of shortening an assembly time and achieving a cost reduction without the need to make a highly-precise assembly adjustment.

### BRIEF DESCRIPTION OF THE DRAWINGS

FIG. 1 shows a schematic configuration of an optical semiconductor device according to Embodiment 1 of the present invention.

FIG. 2 is a plan view showing an emitted light beam branching element in the optical semiconductor device according to Embodiment 1 of the present invention.

FIG. 3A is a drawing for describing a light beam of a main beam reflected from an optical disk in the optical semiconductor device according to Embodiment 1 of the present invention.

FIG. 3B is a drawing for describing light beams of first and second sub beams reflected from the optical disk in the optical semiconductor device according to Embodiment 1 of the present invention.

FIG. 3C is a drawing for describing light beams of third and fourth sub beams reflected from the optical disk in the optical semiconductor device according to Embodiment 1 of the present invention.

FIG. 4 shows where beam spots are located on the optical disk in the optical semiconductor device according to Embodiment 1 of the present invention.

FIG. 5 is a plan view showing a light-receiving element in the optical semiconductor device according to Embodiment 1 of the present invention.

FIG. 6 shows a signal waveform of a tracking error signal in the optical semiconductor device according to Embodiment 1 of the present invention, with (a) showing a push-pull signal of the main beam (MPP), (b) showing a push-pull signal of the sub beams (SPP) and (c) showing a tracking error signal (TES).

FIG. 7 is a plan view showing an emitted light beam branching element in an optical semiconductor device according to Embodiment 2 of the present invention.

FIG. 8 shows an intensity distribution of a light beam entering the emitted light beam branching element in the optical semiconductor device according to Embodiment 2 of the present invention.

FIG. 9 is a plan view showing an emitted light beam branching element in an optical semiconductor device according to Embodiment 3 of the present invention when an objective lens is at a neutral position.

FIG. 10 is a plan view showing the emitted light beam branching element in the optical semiconductor device according to Embodiment 3 of the present invention when the objective lens is shifted.

FIG. 11 is a plan view showing an emitted light beam branching element in an optical semiconductor device according to Embodiment 4 of the present invention.

FIG. 12 shows where beam spots are located on an optical disk in the optical semiconductor device according to Embodiment 4 of the present invention.

FIG. 13 shows a schematic configuration of a conventional optical semiconductor device for detecting a tracking signal by a push-pull method.

FIG. 14 is a drawing for describing a light beam reflected from an optical disk in the conventional optical semiconductor device shown in FIG. 13.

FIG. 15 is a drawing for describing a light beam reflected from the optical disk in the conventional optical semiconductor device shown in FIG. 13 when an objective lens is shifted.

FIG. 16 is a drawing for describing a light beam reflected from the optical disk in the conventional optical semiconductor device shown in FIG. 13 when the optical disk is inclined.

FIG. 17 shows a schematic configuration of another conventional optical semiconductor device for detecting a tracking signal by a differential push-pull method.

FIG. 18 shows where beam spots are located on an optical disk in the conventional optical semiconductor device shown in FIG. 17.

FIG. 19 is a plan view showing a light-receiving element in the conventional optical semiconductor device shown in FIG. 17.

FIG. 20 shows a signal waveform of a tracking error signal in the conventional optical semiconductor device shown in FIG. 17, with (a) showing a push-pull signal of a main beam (MPP), (b) showing a push-pull signal of sub beams (SPP) and (c) showing a tracking error signal (TES).

### DETAILED DESCRIPTION OF THE INVENTION

Hereinafter, the present invention will be described more specifically by way of illustrative embodiments.

### Embodiment 1

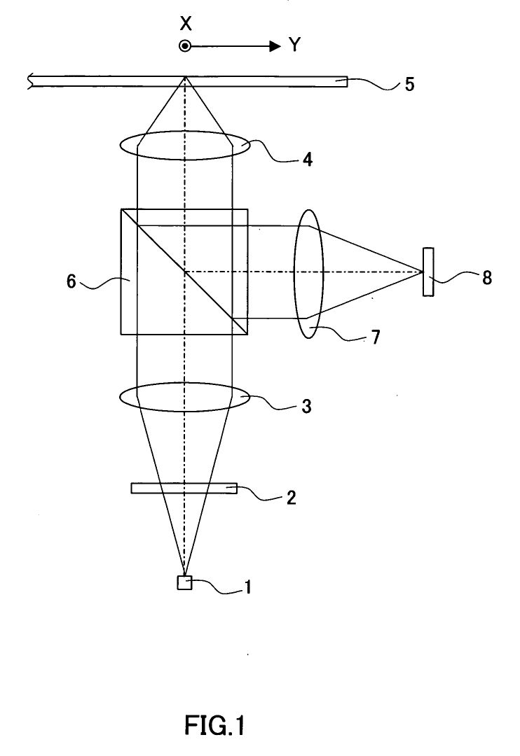

FIG. 1 shows a schematic configuration of an optical semiconductor device according to Embodiment 1 of the present invention.

As shown in FIG. 1, the optical semiconductor device according to the present embodiment includes a semiconductor laser element 1 serving as a light source, an emitted light beam branching element 2 for branching a light beam emitted from the semiconductor laser element 1 into a main beam and a plurality of sub beams, a collimator lens 3 for turning the main beam and the sub beams branched by the emitted light beam branching element 2 into parallel light, an objective lens 4 for focusing the main beam and the sub beams turned into the parallel light by the collimator lens 3 onto an optical disk 5, a beam splitter 6 for reflecting the main beam and the sub beams reflected by the optical disk 5, a light-receiving element 8 for signal detection for detecting each of the main beam and the sub beams reflected by the beam splitter 6, and a focusing lens 7 for focusing the main beam and the sub beams reflected by the beam splitter 6 onto the light-receiving element 8.

A light beam emitted from the semiconductor laser element 1 is branched by the emitted light beam branching element 2 into a main beam and four sub beams. The main beam and the sub beams branched by the emitted light beam branching element 2 are turned into parallel light by the collimator lens 3, pass through the beam splitter 6 and then are focused by the objective lens 4 onto the optical disk 5. The main beam and the sub beams reflected by the optical disk 5 are reflected by the beam splitter 6, focused by the focusing lens 7 onto the light-receiving element 8 and detected.

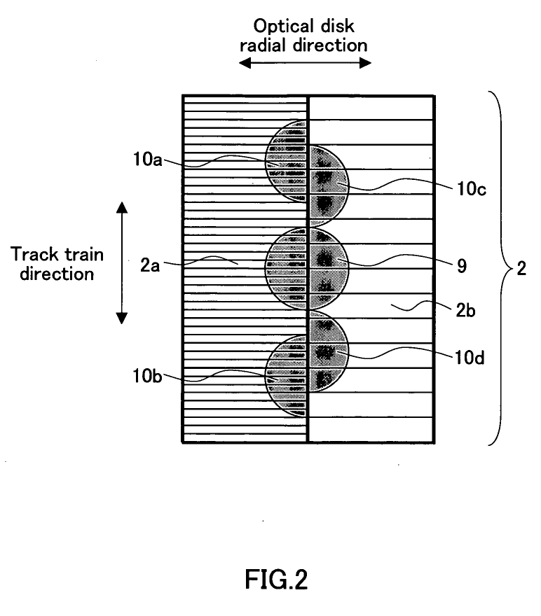

FIG. 2 is a plan view showing the emitted light beam branching element in the optical semiconductor device according to the present embodiment. As shown in FIG. 2, the emitted light beam branching element 2 according to the present embodiment includes a first diffraction grating region 2a and a second diffraction grating region 2b that are aligned along a radial direction of the optical disk 5 (in the following, referred to as an “optical disk radial direction”). The first diffraction grating region 2a and the second diffraction grating region 2b are constituted by gratings extending along the optical disk radial direction that are aligned along a track train direction of the optical disk 5 (in the following, simply referred to as a “track train direction”). Here, a grating pitch of the first diffraction grating region 2a is different from that of the second diffraction grating region 2b. The present embodiment illustrates as an example the case in which the grating pitch of the first diffraction grating region 2a is smaller than that of the second diffraction grating region 2b. Among the light beams that enter the first diffraction grating region 2a and the second diffraction grating region 2b and are diffracted thereby, zero-order light becomes a main beam, +first-order light of the first diffraction grating region 2a becomes a first sub beam, −first-order light of the first diffraction grating region 2a becomes a second sub beam, +first-order light of the second diffraction grating region 2b becomes a third sub beam, and −first-order light of the second diffraction grating region 2b becomes a fourth sub beam. In FIG. 2, numeral 9 indicates a light beam region of the main beam on the emitted light beam branching element 2, and numerals 10a, 10b, 10c and 10d respectively indicate light beam regions of the first, second, third and fourth sub beams on the emitted light beam branching element 2. The light beams leaving these light beam regions enter the objective lens 4 and form the respective beam spots on the optical disk 5.

Here, the light beam region 9 of the main beam on the emitted light beam branching element 2 has a light distribution in the shape of the objective lens 4, in other words, a circular light distribution. On the other hand, each of the light beam regions 10a, 10b, 10c and 10d of the first, second, third and fourth sub beams on the emitted light beam branching element 2 has a semicircular light distribution. This is because, owing to the difference in a diffraction angle caused by the difference in the grating pitch between the first diffraction grating region 2a and the second diffraction grating region 2b, the light beam region 10a in the first diffraction grating region 2a and the light beam region 10c in the second diffraction grating region 2b are separated in the track train direction and the light beam region 10b in the first diffraction grating region 2a and the light beam region 10d in the second diffraction grating region 2b are separated in the track train direction.

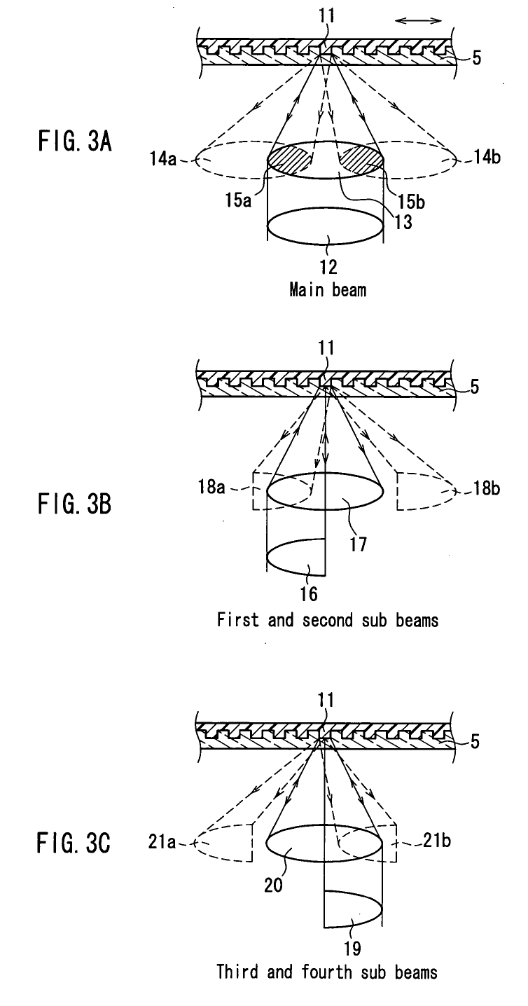

FIG. 3 is a drawing for describing light beams of the main beam and the sub beams reflected from the optical disk in the optical semiconductor device according to the present embodiment. Here, FIG. 3A shows the case of the main beam, FIG. 3B shows the case of the first and second sub beams and, FIG. 3C shows the case of the third and fourth sub beams. As shown in FIG. 3A, a main beam 12 having a circular light distribution is reflected and diffracted by a track 11 on the optical disk 5, and interference regions 15a and 15b appear in the reflected light beam due to an interference between zero-order diffraction light 13 and +first-order diffraction light 14a and that between the zero-order diffraction light 13 and −first-order diffraction light 14b. Then, from the contrast between these interference regions 15a and 15b, a push-pull signal is detected. On the other hand, as shown in FIGS. 3B and 3C, in the case of first and second sub beams 16 and third and fourth sub beams 19 having a semi-circular light distribution, zero-order diffraction lights 17, 20, +first-order diffraction lights 18a, 21a and −first-order diffraction lights 18b, 21b reflected and diffracted by the track 11 on the optical disk 5 also become semi-circular, so that an interference region is reduced or hardly is generated. For example, in the case where the distance between tracks is as small as about 0.74 μm as in a DVD-R (digital versatile disk recordable), a reflection diffraction angle is large, so that the interference region hardly is generated. Also, in the case where the distance between tracks (between grooves) is as large as about 1.23 μm as in a DVD-RAM (digital versatile disk random access memory), the interference region is generated partially, but a component modulated by the track hardly is generated or is so small as to be negligible compared with the push-pull signal of the main beam.

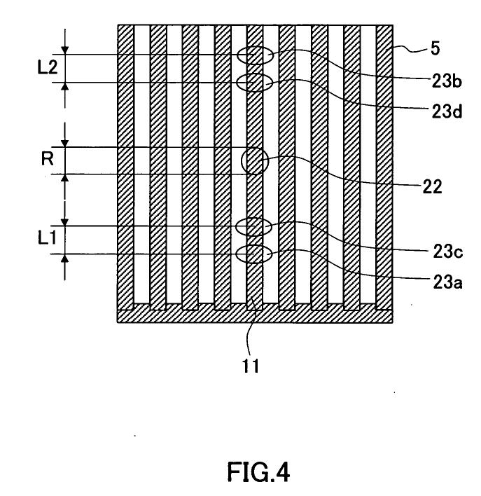

FIG. 4 shows where beam spots are located on the optical disk in the optical semiconductor device according to the present embodiment. As shown in FIG. 4, a main beam 22, a first sub beam 23a, a second sub beam 23b, a third sub beam 23c and a fourth sub beam 23d are adjusted to be located on the optical disk 5 so as to satisfy
L1≧R and L2≧R,
where R indicates a spot size of the main beam 22, L1 indicates the space between the first sub beam 23a and the third sub beam 23c, and L2 indicates the space between the second sub beam 23b and the fourth sub beam 23d. Here, the spot size refers to a diameter of the range where the light intensity is 1/e² of that of a spot center. With this configuration, the individual sub beams are separated sufficiently in the track train direction, so that the interference region between the zero-order diffraction light and the ±first-order diffraction lights of the sub beams reflected by the optical disk 5 hardly is generated. Incidentally, although the first sub beam 23a, the second sub beam 23b, the third sub beam 23c and the fourth sub beam 23d are located on the track 11 in FIG. 4, no problem arises even if they are located irrespective of the position of the track 11.

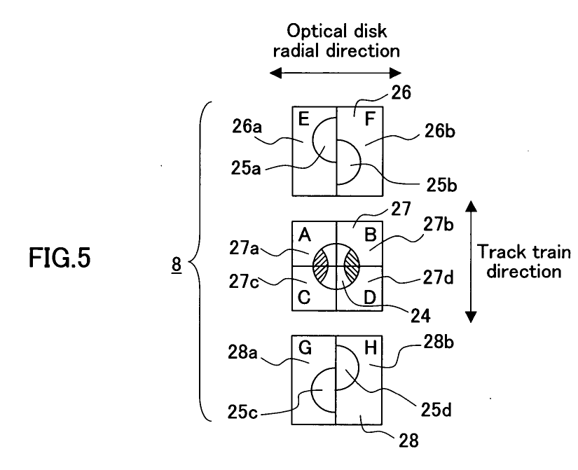

The main beam and the sub beams reflected by the optical disk 5 are detected by the light-receiving element 8 arranged as shown in FIG. 5. FIG. 5 is a plan view showing the light-receiving element in the optical semiconductor device according to the present embodiment. As shown in FIG. 5, the light-receiving element 8 includes three light-receiving elements 26, 27 and 28 that are aligned along the track train direction. The central light-receiving element 27 having four light-receiving regions 27a, 27b, 27c and 27d obtained by division into two parts along the optical disk radial direction and division into two parts along the track train direction is used for detecting a main beam. When A, B, C and D respectively indicate output signals of the light-receiving regions 27a, 27b, 27c and 27d, a push-pull signal of a main beam 24 (MPP) is calculated by
MPP=(A+C)−(B+D).
This push-pull signal of the main beam contains a component modulated at the time of crossing a track and a DC offset component generated by the shift of the objective lens 4 and the inclination of the optical disk 5. On the other hand, the light-receiving elements 26 and 28 on both sides of the light-receiving element 27 respectively have two-divided light-receiving regions 26a, 26b that are aligned along the optical disk radial direction and two-divided light-receiving regions 28a, 28b that are aligned along the optical disk radial direction. These light-receiving elements 26 and 28 are used for detecting sub beams. When E, F, G and H respectively indicate output signals of the light-receiving regions 266a, 26b, 28a and 28b, a push-pull signal of sub beams 256a, 25b, 25c and 25d (SPP) is calculated by
SPP=(E+G)−(F+H).
In this manner, the push-pull signal of the sub beams is calculated by the difference in the optical disk radial direction, making it possible to detect a DC offset signal having the same phase as the main beam. Since none of the four sub beams has an interference region between zero-order light and +first-order lights of the reflected and diffracted light, the push-pull signal of these sub beams contains no component modulated at the time of crossing a track.

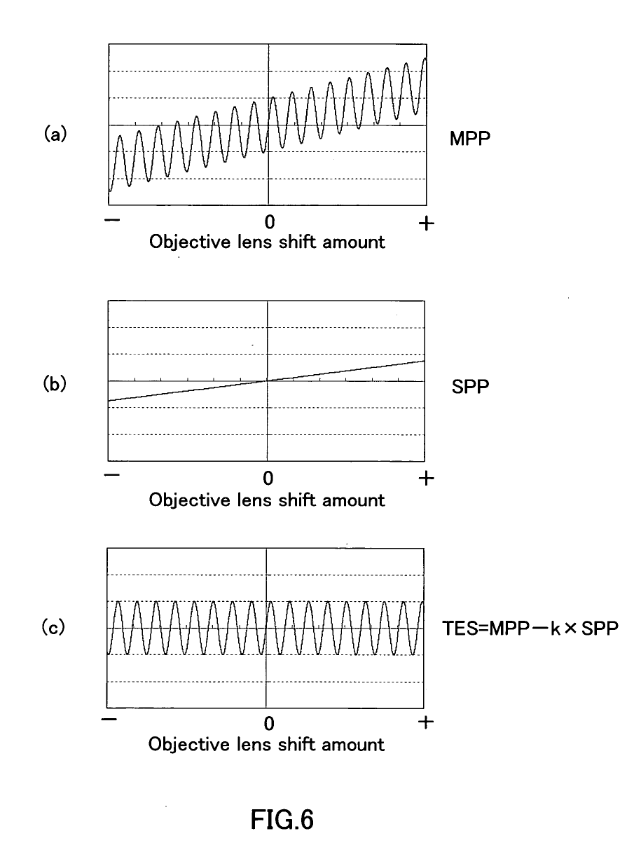

FIG. 6 shows signal waveforms of these signals when the objective lens is shifted. By detecting a tracking error signal (TES) using arithmetic expressions below, it is possible to cancel the DC offset signal generated by the shift of the objective lens 4 and the inclination of the optical disk 5.
TES=MPP−k×SPP
k=α/β
α: light intensity of the main beam
β: light intensity of the sub beams

Since the push-pull signal of the sub beams contains no component modulated at the time of crossing a track in this configuration, the sub beams may be located anywhere on the optical disk irrespective of the track position. This allows information to be recorded on and reproduced from optical disks of plural specifications having different track pitches using a single optical semiconductor device. Furthermore, there is no need to adjust the locations of the sub beams at the time of assembling and adjusting the optical semiconductor device, making it possible to shorten an assembly time and achieve a cost reduction.

### Embodiment 2

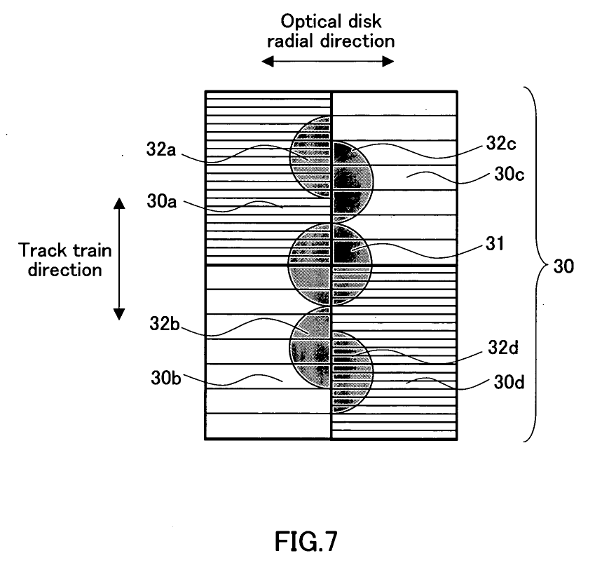

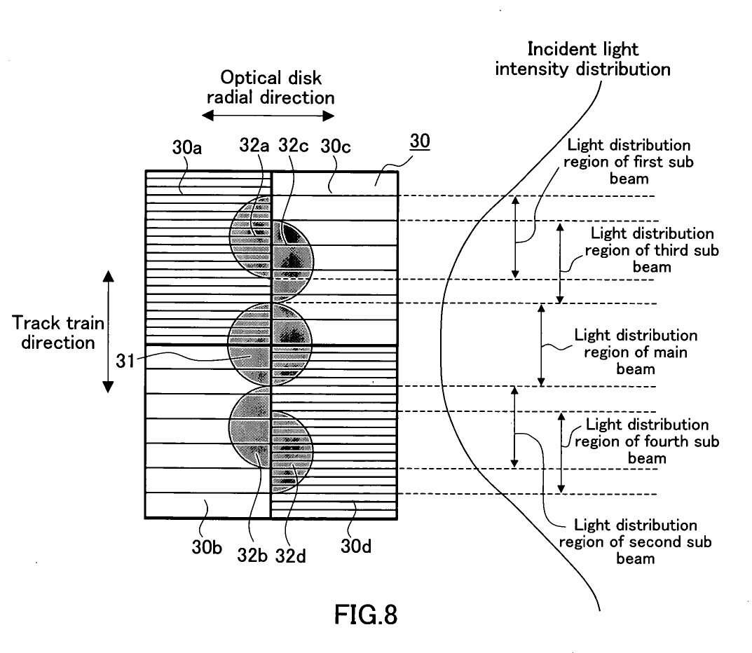

An optical semiconductor device according to the present embodiment has the same basic configuration as the above-described optical semiconductor device according to Embodiment 1 shown in FIG. 1 except for the configuration of the emitted light beam branching element. FIG. 7 is a plan view showing an emitted light beam branching element in the optical semiconductor device according to Embodiment 2 of the present invention, and FIG. 8 shows an intensity distribution of a light beam entering this emitted light beam branching element.

As shown in FIG. 7, an emitted light beam branching element 30 according to the present embodiment includes a first diffraction grating region 30a and a second diffraction grating region 30b that are aligned along the track train direction and a third diffraction grating region 30c and a fourth diffraction grating region 30d that are aligned with the first diffraction grating region 30a and the second diffraction grating region 30b respectively along the optical disk radial direction. The first diffraction grating region 30a, the second diffraction grating region 30b, the third diffraction grating region 30c and the fourth diffraction grating region 30d are constituted by gratings extending along the optical disk radial direction that are aligned along the track train direction. The first diffraction grating region 30a and the fourth diffraction grating region 30d diagonally opposite thereto have an equal grating pitch. Also, the second diffraction grating region 30b and the third diffraction grating region 30c diagonally opposite thereto have an equal grating pitch that is different from the grating pitch of the first and fourth diffraction grating regions 30a and 30d. The present embodiment illustrates as an example the case in which the grating pitch of the first and fourth diffraction grating regions 30a and 30d is smaller than that of the second and third diffraction grating regions 30b and 30c. Among the light beams that enter the first diffraction grating region 30a, the second diffraction grating region 30b, the third diffraction grating region 30c and the fourth diffraction grating region 30d and are diffracted thereby, zero-order light becomes a main beam, +first-order light of the first diffraction grating region 30a becomes a first sub beam, −first-order light of the second diffraction grating region 30b becomes a second sub beam, +first-order light of the third diffraction grating region 30c becomes a third sub beam, and −first-order light of the fourth diffraction grating region 30d becomes a fourth sub beam. In FIG. 7, numeral 31 indicates a light beam region of the main beam on the emitted light beam branching element 30, and numerals 326a, 32b, 32c and 32d respectively indicate light beam regions of the first, second, third and fourth sub beams on the emitted light beam branching element 30. The light beams leaving these light beam regions enter the objective lens 4 and form the respective beam spots on the optical disk 5 (see FIG. 1). In this case, the light beam region 31 of the main beam on the emitted light beam branching element 30 also has a circular light distribution and each of the light beam regions 326a, 32b, 32c and 32d of the first, second, third and fourth sub beams on the emitted light beam branching element 30 also has a semicircular light distribution, similarly to Embodiment 1 described above.

With this configuration, even when the light intensity distribution of the light beam entering the emitted light beam branching element 30 has a steep Gaussian shape in the track train direction as shown in FIG. 8, for example, the sum of the first sub beam and the second sub beam and the sum of the third sub beam and the fourth sub beam are equal, so that no offset caused by the light intensity distribution of the light beam entering the emitted light beam branching element 30 is generated. Consequently, even in the case where a semiconductor laser element with a small angle of divergence is mounted or where an optical system with a low optical magnification is used, it becomes possible to detect a stable tracking error signal without any offset.

Also in the optical semiconductor device according to the present embodiment, the main beam, the first, second, third and fourth sub beams are adjusted to be located on the optical disk 5 so as to satisfy
L1≧R and L2≧R,
similarly to Embodiment 1 described above, where R indicates a spot size of the main beam, L1 indicates the space between the first sub beam and the third sub beam, and L2 indicates the space between the second sub beam and the fourth sub beam. With this configuration, the individual sub beams are separated sufficiently in the track train direction, so that the interference region between the zero-order diffraction light and the ±first-order diffraction lights of the sub beams reflected by the optical disk 5 hardly is generated.

### Embodiment 3

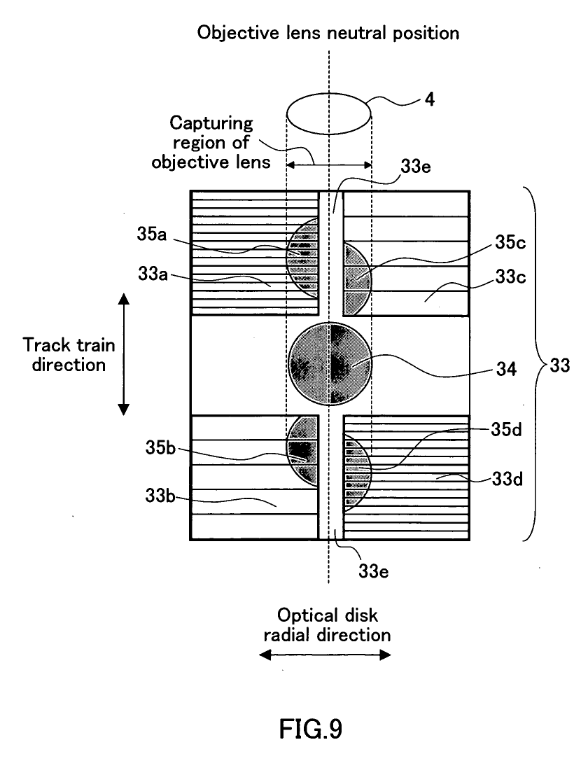

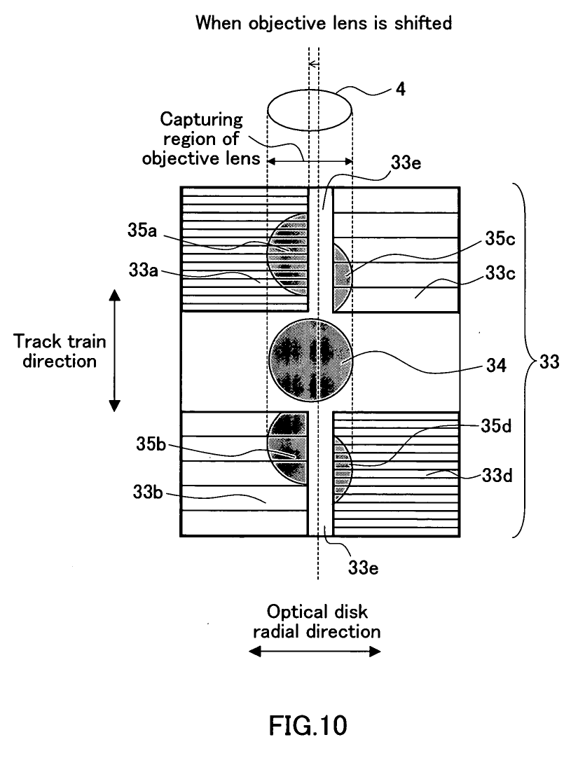

An optical semiconductor device according to the present embodiment has the same basic configuration as the above-described optical semiconductor device according to Embodiment 1 shown in FIG. 1 except for the configuration of the emitted light beam branching element. FIG. 9 is a plan view showing an emitted light beam branching element in the optical semiconductor device according to Embodiment 3 of the present invention, and FIG. 10 is a plan view showing the main beam and sub beams in this emitted light beam branching element when an objective lens is shifted.

As shown in FIGS. 9 and 10, an emitted light beam branching element 33 according to the present embodiment is divided into three parts both along the optical disk radial direction and along the track train direction, and four corner areas of the emitted light beam branching element 33 are provided with a first diffraction grating 33a, a second diffraction grating 33b, a third diffraction grating 33c and a fourth diffraction grating 33d for generating sub beams. The first diffraction grating 33a and the second diffraction grating 33b are aligned along the track train direction. Also, the third diffraction grating 33c and the fourth diffraction grating 33d are aligned with the first diffraction grating 33a and the second diffraction grating 33b respectively along the optical disk radial direction. The first diffraction grating 33a, the second diffraction grating 33b, the third diffraction grating 33c and the fourth diffraction grating 33d are constituted by gratings extending along the optical disk radial direction that are aligned along the track train direction. Here, the first diffraction grating 33a and the fourth diffraction grating 33d diagonally opposite thereto have an equal grating pitch. Also, the second diffraction grating 33b and the third diffraction grating 33c diagonally opposite thereto have an equal grating pitch that is different from the grating pitch of the first and fourth diffraction gratings 33a and 33d. The present embodiment illustrates as an example the case in which the grating pitch of the first and fourth diffraction gratings 33a and 33d is smaller than that of the second and third diffraction gratings 33b and 33c. Among the light beams that enter the first diffraction grating 33a, the second diffraction grating 33b, the third diffraction grating 33c and the fourth diffraction grating 33d and are diffracted thereby, +first-order light of the first diffraction grating 33a becomes a first sub beam, −first-order light of the second diffraction grating 33b becomes a second sub beam, +first-order light of the third diffraction grating 33c becomes a third sub beam, and -first-order light of the fourth diffraction grating 33d becomes a fourth sub beam. In FIGS. 9 and 10, numeral 34 indicates a light beam region of the main beam on the emitted light beam branching element 33, and numerals 35a, 35b, 35c and 35d respectively indicate light beam regions of the first, second, third and fourth sub beams on the emitted light beam branching element 33. The light beams leaving these light beam regions enter the objective lens 4 and form the respective beam spots on the optical disk 5 (see FIG. 1).

Moreover, in this emitted light beam branching element 33, a flat surface region 33e without any diffraction grating is formed between the first diffraction grating 33a and the third diffraction grating 33c that are aligned along the optical disk radial direction and between the second diffraction grating 33b and the fourth diffraction grating 33d that are aligned along the optical disk radial direction. Therefore, when the objective lens 4 is at a neutral position as shown in FIG. 9, the light beam regions 35a, 35b, 35c and 35d of the first, second, third and fourth sub beams on the emitted light beam branching element 33 have a shape narrower than a semi-circular shape in the optical disk radial direction. Thus, in accordance with this configuration, the generation of the interference region between the zero-order diffraction light and the ±first-order diffraction lights reflected and diffracted by the track 11 on the optical disk 5 (see FIG. 3) can be suppressed further. Also, when the objective lens 4 is shifted as shown in FIG. 10, the light beam regions 356a, 35b, 35c and 35d of the first, second, third and fourth sub beams on the emitted light beam branching element 33 can be made to have a shape narrower than a semicircular shape in the optical disk radial direction. Consequently, even when the objective lens 4 is shifted, it becomes possible to detect a stable tracking error signal without any offset.

### Embodiment 4

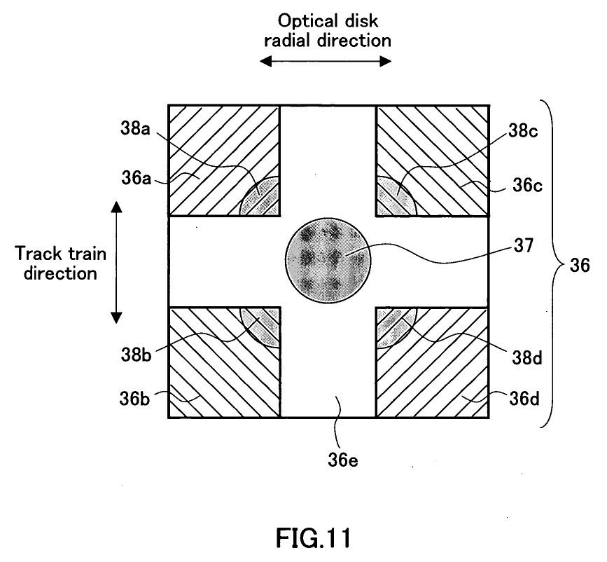

An optical semiconductor device according to the present embodiment has the same basic configuration as the above-described optical semiconductor device according to Embodiment 1 shown in FIG. 1 except for the configuration of the emitted light beam branching element. FIG. 11 is a plan view showing an emitted light beam branching element in Embodiment 4 of the present invention.

As shown in FIG. 11, an emitted light beam branching element 36 according to the present embodiment is divided into three parts both along the optical disk radial direction and along the track train direction, and four corner areas of the emitted light beam branching element 36 are provided with a first diffraction grating 36a, a second diffraction grating 36b, a third diffraction grating 36c and a fourth diffraction grating 36d for generating sub beams. The first diffraction grating 36a and the second diffraction grating 36b are aligned along the track train direction. Also, the third diffraction grating 36c and the fourth diffraction grating 36d are aligned with the first diffraction grating 36a and the second diffraction grating 36b respectively along the optical disk radial direction. Each of the first diffraction grating 36a, the second diffraction grating 36b, the third diffraction grating 36c and the fourth diffraction grating 36d is constituted by gratings extending along an oblique direction to the optical disk radial direction that are aligned along a direction orthogonal to the above-noted oblique direction. With this configuration, light beam regions 38a, 38b, 38c and 38d of the sub beams on the emitted light beam branching element 36 can be set freely by the direction of the gratings. Thus, both in the cases where the objective lens 4 is at a neutral position and where the objective lens 4 is shifted, the light beam regions 38a, 38b, 38c and 38d of the sub beams can be made to have a shape narrower than a semi-circular shape in the optical disk radial direction. The present embodiment illustrates as an example the case in which the gratings of the first to fourth diffraction gratings 36a to 36d extend in a direction at an angle of 45° with respect to the optical disk radial direction. Here, the first diffraction grating 36a and the fourth diffraction grating 36d diagonally opposite thereto have the gratings extending in the same direction, and the second diffraction grating 36b and the third diffraction grating 36c diagonally opposite thereto have the gratings extending orthogonally to the gratings of the first diffraction grating 36a and the fourth diffraction grating 36d.

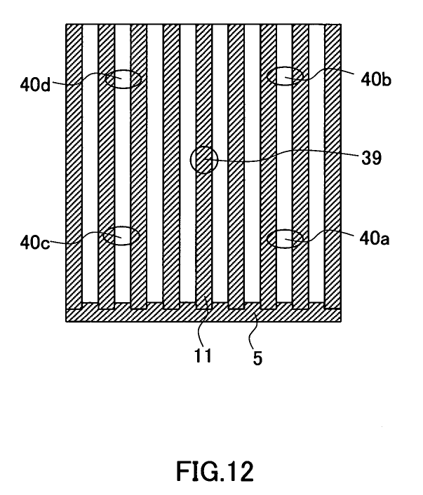

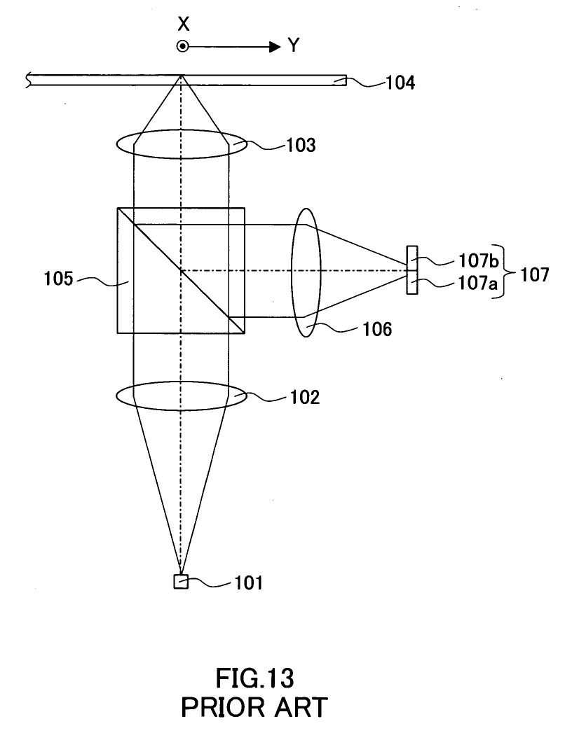

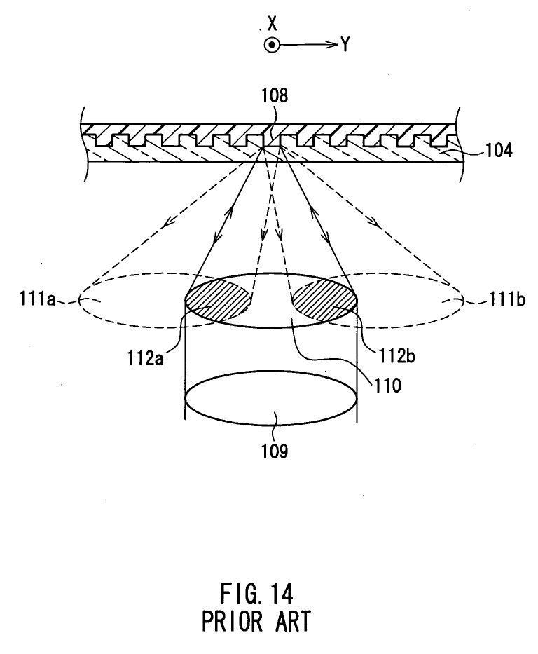

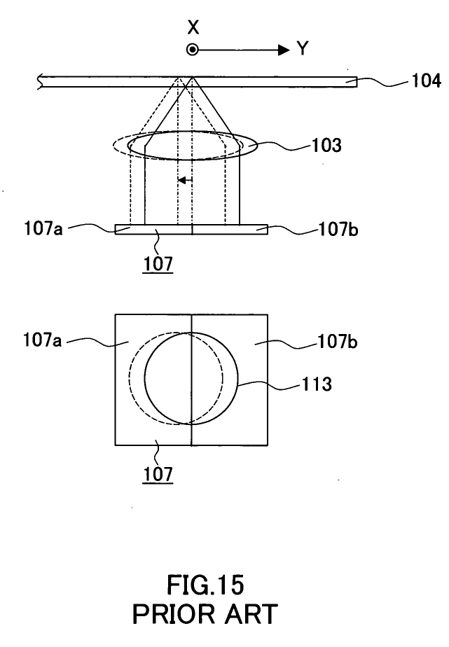

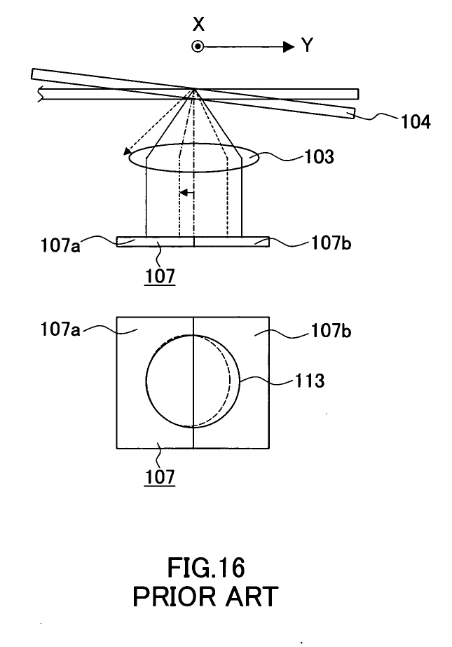

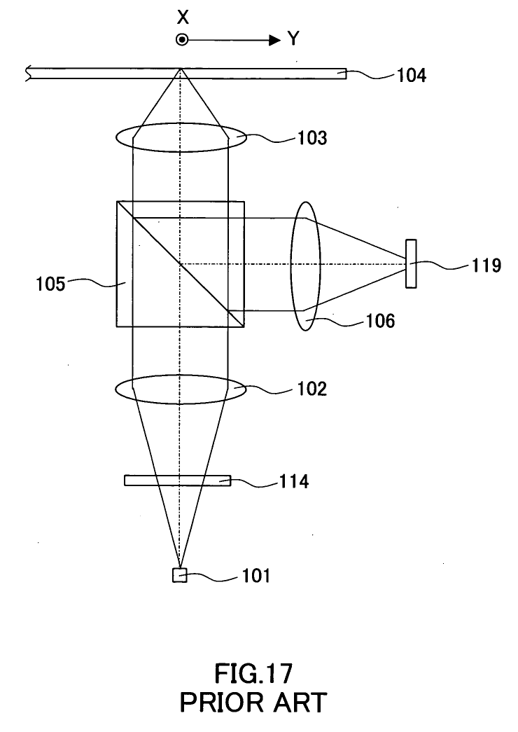

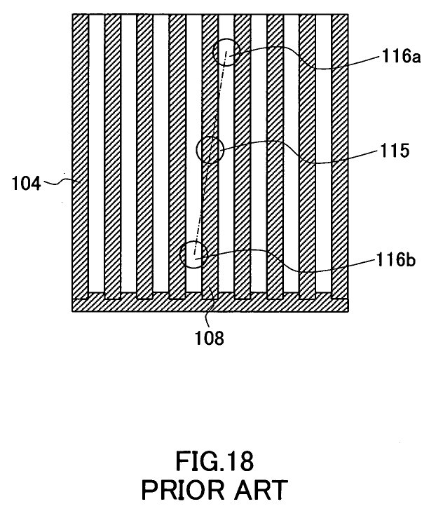

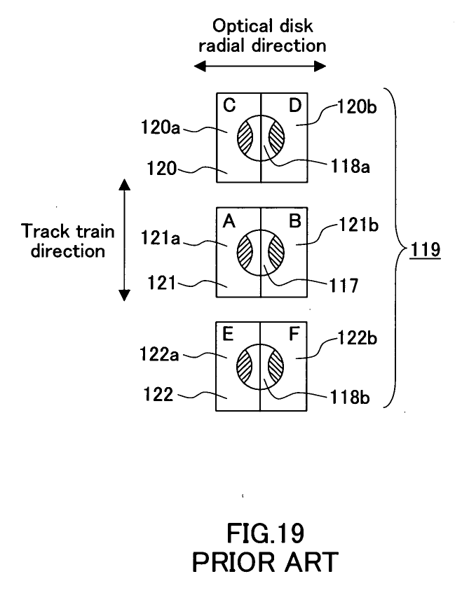

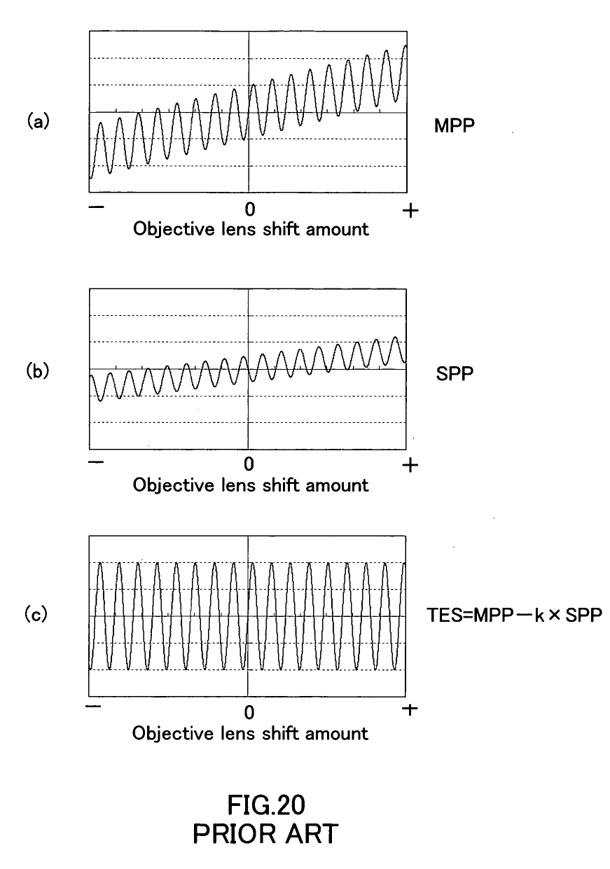

FIG. 12 shows where beam spots are located on the optical disk in the optical semiconductor device according to the present embodiment. The gratings extending in the oblique direction to the optical disk radial direction are aligned in the direction orthogonal to the above-noted oblique direction, thereby forming the first diffraction grating 36a, the second diffraction grating 36b, the third diffraction grating 36c and the fourth diffraction grating 36d for generating sub beams according to the present embodiment. Therefore, as shown in FIG. 12, a first sub beam 40a, a second sub beam 40b, a third sub beam 40c and a fourth sub beam 40d are located on the optical disk 5 also at positions in the oblique direction to the optical disk radial direction with respect to a main beam 39. However, no problem is caused even if the first sub beam 40a, the second sub beam 40b, the third sub beam 40c and the fourth sub beam 40d are located irrespective of the position of the track 11.

With the above-described configuration, the generation of the interference region between zero-order diffraction light and ±first-order diffraction lights reflected and diffracted by the track 11 on the optical disk 5 can be suppressed further, making it possible to detect a stable tracking error signal without any offset.

With the optical semiconductor device according to the present invention, the sub beams can be located on the optical disk irrespective of the position of the track. Accordingly, the optical semiconductor device according to the present invention is useful in the case of recording and reproducing information with respect to optical disks of plural specifications having different track pitches.

The invention may be embodied in other forms without departing from the spirit or essential characteristics thereof The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. An optical semiconductor device comprising:
a semiconductor laser element;
an emitted light beam branching element for branching a light beam emitted from the semiconductor laser element into a main beam and a plurality of sub beams;
an objective lens for focusing the main beam and the sub beams branched by the emitted light beam branching element onto an optical disk; and
a light-receiving element for signal detection for detecting each of the main beam and the sub beams reflected by the optical disk;
wherein a light distribution of the sub beams branched by the emitted light beam branching element has a shape equal to or narrower in an optical disk radial direction than a shape obtained by bisecting a light distribution of the main beam when the sub beams enter the objective lens.

2. The optical semiconductor device according to claim 1, wherein the emitted light beam branching element comprises a first diffraction grating region and a second diffraction grating region that are aligned along the optical disk radial direction, and a grating pitch of the first diffraction grating region is different from that of the second diffraction grating region.

3. The optical semiconductor device according to claim 2, wherein, when the sub beam that is +first-order diffracted by the first diffraction grating region is a first sub beam, the sub beam that is −first-order diffracted by the first diffraction grating region is a second sub beam, the sub beam that is +first-order diffracted by the second diffraction grating region is a third sub beam and the sub beam that is −first-order diffracted by the second diffraction grating region is a fourth sub beam, both of a space between the first sub beam and the third sub beam and a space between the second sub beam and the fourth sub beam are equal to or larger than a spot size of the main beam on the optical disk.

4. The optical semiconductor device according to claim 1, wherein the emitted light beam branching element comprises a first diffraction grating region and a second diffraction grating region that are aligned along a track train direction and a third diffraction grating region and a fourth diffraction grating region that are aligned with the first diffraction grating region and the second diffraction grating region respectively along the optical disk radial direction, the first and fourth diffraction grating regions have an equal grating pitch, and the second and third diffraction grating regions have an equal grating pitch that is different from the grating pitch of the first and fourth diffraction grating regions.

5. The optical semiconductor device according to claim 4, wherein, when the sub beam that is +first-order diffracted by the first diffraction grating region is a first sub beam, the sub beam that is −first-order diffracted by the second diffraction grating region is a second sub beam, the sub beam that is +first-order diffracted by the third diffraction grating region is a third sub beam and the sub beam that is −first-order diffracted by the fourth diffraction grating region is a fourth sub beam, both of a space between the first sub beam and the third sub beam and a space between the second sub beam and the fourth sub beam are equal to or larger than a spot size of the main beam on the optical disk.

6. The optical semiconductor device according to claim 1, wherein the emitted light beam branching element is divided into three parts both along the optical disk radial direction and along a track train direction, and four corner areas of the emitted light beam branching element are provided with diffraction gratings for generating the sub beams.

7. The optical semiconductor device according to claim 6, wherein the diffraction gratings for generating the sub beams comprise a first diffraction grating and a second diffraction grating that are aligned along the track train direction and a third diffraction grating and a fourth diffraction grating that are aligned with the first diffraction grating and the second diffraction grating respectively along the optical disk radial direction, the first and fourth diffraction gratings have an equal grating pitch, and the second and third diffraction gratings have an equal grating pitch that is different from the grating pitch of the first and fourth diffraction gratings.

8. The optical semiconductor device according to claim 6, wherein the diffraction gratings for generating the sub beams comprise a first diffraction grating and a second diffraction grating that are aligned along the track train direction and a third diffraction grating and a fourth diffraction grating that are aligned with the first diffraction grating and the second diffraction grating respectively along the optical disk radial direction, and the first to fourth diffraction gratings are constituted by gratings extending along an oblique direction to the optical disk radial direction that are aligned along a direction orthogonal to the oblique direction.
